(19) United States
(12) Patent Application Publication
(10) Pub. No.: US 2005/0146137 A1
(43) Pub. Date: Jul. 7, 2005

(54) Mechanical joints for subsea equipment

(75) Inventors: Ian McClymont Davidson, Caireyhill (GB); Stuart Jan Spitz, Dunfermline (GB); Christopher D. Bartlett, Spring, TX (US); Knut Havard Bekkevold, Hof (NO)

Correspondence Address: Henry C Query Jr, 504 S Pierce Avenue, Wheaton, IL, 60187, US

(73) Assignee: FMC Technologies, Inc., Chicago, IL (US)

(21) Appl. No.: 10/498,021

(22) PCT Filed: Dec. 5, 2002
(86) PCT No.: PCT/GB02/05491

(30) Foreign Application Priority Data
Dec. 5, 2001 (NO) 20015954

(51) Int. Cl. F16L 39/00

(52) U.S. Cl. 285/322; 285/920

(57) ABSTRACT

A mechanical connector for oil and gas well apparatus applies a predetermined preload across the connection, the preload being adapted to accommodate relatively large dimensional tolerances in the loadpath of the connector preload by placing a component with a low modulus of elasticity within that load path. In one embodiment, the connector comprises fingers (3) of a pair of pipe flanges (1, 1′), a stationary retainer ring (14) against which a finger reaction surface (13) is pressed, a runner ring (15) located outside the fingers and movable lengthwise along the fingers by an actuator (16), the retainer ring and the runner ring having an elasticity that is so large that deviations in their elongation only have a small influence on the retainer ring and the runner ring radial pressure against the fingers and clamping forces of the fingers against the flanges. In a second embodiment, the connector comprises dogs (103, FIG. 4) located around the circumference of a first tubular joint component, a follower located outside the dogs (103) and movable axially of the dogs, the low elastic modulus component being a ring located in the loadpath below the dogs. In a third embodiment, the connector comprises a lockdown mechanism acting between nested components, the low elastic modulus component being an insert comprising a load shoulder transferring loads between the nested components.

### BACKGROUND OF THE INVENTION

The present invention relates to the use of a low modulus elastic insert as a component within the loadpath of load transferring structures. More specifically, the invention relates to connectors and joints for oil and gas wells having such inserts.

Many joints are required to apply specific preload between two pieces of equipment. Variations in finished component dimensions lead to a potential variation in the applied preload when the joint is locked in place. These potential variations limit the load capacity of the joint, as the specified preload value must accommodate the uncertainty of the actual preload as well as the applied stress in the joint when in use.

Many structures, when joined together, can experience large bending moments and/or tensile loads and must be highly preloaded in order to resist such loading. This is especially true for connectors used in subsea applications, such as pipeline collet connectors and wellhead connectors. Tubing hangers, when locked in a wellhead or a christmas tree, may also be exposed to such large bending moments. Similarly, riser pipe and foundation casing string joints (e.g. 20″ and 30″ casing joints) can also experience large bending moments. Relatively highly preloaded joints are also found in tree caps, casing hanger lock down bushings, packoffs and flowline connectors.

For example, offshore operations usually require that a flowline for transporting hydrocarbons from the well is attached to a hub on a christmas tree. In this case a termination head including a connector is first laid on the seabed and then later drawn in to engage with the hub. A seal is located between the termination head and the hub face. A locking element, which in the case of a collet connector is a set of fingers, is moved from an open position to a closed position in engagement with an external profile on the hub. In this type of connector large tensile forces and bending moments may be experienced due to the forces required to bring the two ends toward each other.

Also, offshore operations may require a riser, a BOP and riser, a spool or a Christmas tree to be connected to a wellhead. In this case a wellhead connector bolts to the lower end of, for example, a blowout preventer (BOP) stack, which in turn is run at the bottom of the riser. An upper body of the wellhead connector is attached to or forms part of the BOP. A lower body is bolted to the upper body. The BOP has a downward facing shoulder that lands on the upper rim of the wellhead housing. A seal is located between the BOP shoulder and the wellhead housing rim. Locking elements, usually a set of dogs or a lock ring, are pushed out from a retracted position in the lower body to engage an external profile on the wellhead housing. This type of connector, although functional, has shortcomings in that large bending moments and tension applied to the riser may cause the connector to move slightly relative to the wellhead housing.

Known connectors of this type utilize a tapered wedge for actuating the locking elements to achieve a desired compressive preload at the joint mating surfaces. Typical examples of such connectors are shown in U.S. Pat. Nos. 4,526,406 and 4,856,594. However, accurate preloading depends on the joint and connector components being in perfect condition. Any increased friction factors or component dimensional inaccuracies due to, for instance, wear, corrosion and manufacturing or assembly tolerances will counter the ability to determine true preload. This introduces the need for greater design safety factors and larger, heavier joints and connectors.

Another solution to this problem is discussed in U.S. Pat. No. 6,138,762. This invention uses downward deflection of a connector to provide an interference fit between the connector lower body and the outer diameter of the wellhead housing, at a distance below the wellhead housing upper rim. This increases the bending capacity of the connector by providing a secondary load path for the applied bending moment, but entails a further, precisely toleranced machine fit which increases manufacture costs.

To ensure a secure, leak-tight connection in all of the joints and connectors discussed above, it is necessary to apply a preload to the connecting parts. The accurate control of applied preload will increase the load capacity and possible applications of the connector. A preload may be applied to joints for two main reasons: to draw two parts together tightly enough to prevent leakage across the joint and, in the case of a joint subject to large and variable bending moments, the preload compressive stress should exceed the maximum tensile bending stress level in the connector. In the second instance the reason for preload is that materials repeatedly cycled through compression and elongation will quickly suffer fatigue failure.

### SUMMARY OF THE INVENTION

The present invention provides a mechanical connector which in use applies a predetermined preload across a load transferring connection formed between parts of oil or gas well apparatus, characterised in that a component having a low modulus of elasticity in comparison to the remainder of the preload path is placed in the preload path so that the connector is adapted to accommodate larger dimensional tolerances in components forming the preload path for a given variation in the predetermined preload. This can be used to greatly reduce the margin of uncertainty in the preload value inherent in the variability of machining tolerances, wear, corrosion and assembly variances of the mating parts. Reduced uncertainty will allow a higher operating range for the connector. It will also allow the connector to be stiffer, providing much stronger connections. This uncertainty has previously restricted the upper stiffness limits for the connection.

The low modulus of elasticity of the component inserted within the load path greatly reduces the variation in stress/preload when compared to previous designs. The invention further allows a stiffer connector design with still improved setting tolerance.

The insert may be a superelastic material in which case the component is designed such that operating load is in the highly elastic region. Superelasticity is a property of so-called shape memory alloys and similar materials. The crystalline lattice structure of a shape memory alloy changes from the austenitic form at higher temperatures to the martensitic form at lower temperatures. When a stress load is applied to these materials at temperatures just above that at which results in the phase transformation, the austenitic form is progressively changed to the more easily deformable martensitic form. Considerable deformations can therefore be produced for only relatively modest increases in applied stress. When the load is removed, martensite changes back to austenite. During this loading/unloading process, these materials therefore behave elastically, but with a low Young's Modulus, typically about one eighth that of steel. Care must be taken however to choose materials such that operating load would be in the superelastic region (see FIG. 7). Other suitable low modulus materials include titanium, carbon, carbon fiber and other composites.

The component, such as a ring or a series of parts, is stressed by the same load as the connection. The low modulus provides a greater strain for the same stress when compared to components manufactured from conventional materials.

Further objects, constructive embodiments and advantages of the invention will be apparent from the detailed description and the drawings.

### BRIEF DESCRIPTION OF THE DRAWINGS

FIG. 1 is a longitudinal section through two pipe flanges and a pipe connector forming a joint and connector embodying the invention;

FIG. 2 shows a retainer ring of the FIG. 1 connector, with the connector closed;

FIG. 3 shows a runner ring of the FIG. 1 connector, with the connector closed;

FIG. 4 is a longitudinal cross-sectional view through a wellhead and wellhead connector forming a second embodiment of the invention;

FIG. 5 is a view through the connector of FIG. 4, showing loadpaths;

FIG. 6 is a longitudinal half-sectional view through a tubing hanger lockdown mechanism forming a third embodiment of the invention, and

FIG. 7 is a graph showing the preferred region of elasticity of a superelastic material.

### DESCRIPTION OF THE PREFERRED EMBODIMENTS

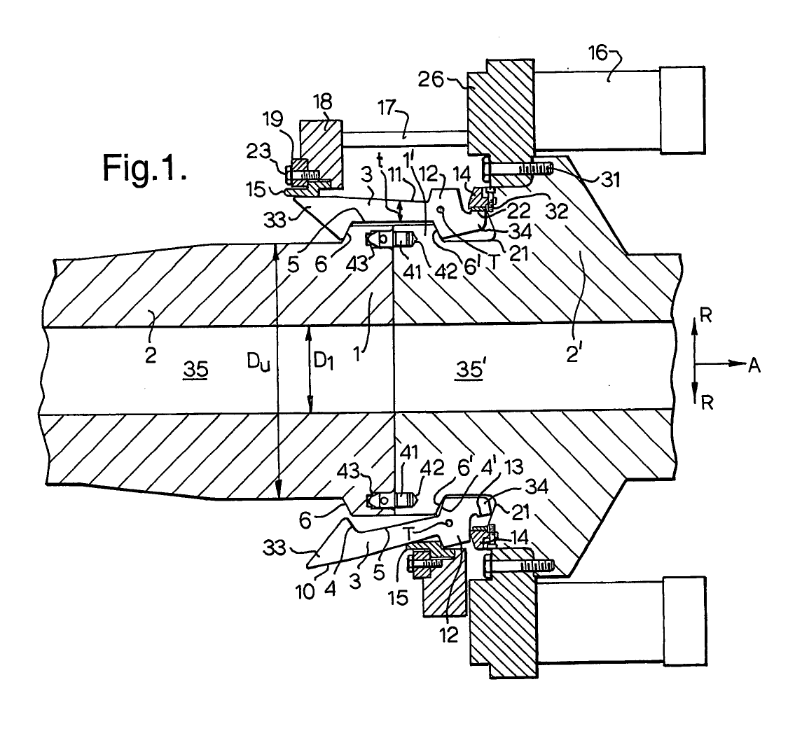

FIG. 1 shows two pipe components 2, 2′ each with a flow passage 35, 35′. The pipe components 2, 2′ may be parts of equipment that is part of an underwater pipe system for hydrocarbons. For example, the left component 2 can be a pipe while the right component 2′ can be a hub on a pressure tank. The pipe components each have a flange 1, 1′. By placing the flanges 1, 1′ facing each other as shown on FIG. 1, a connection or joint between the flow passages 35, 35′ is established, so that fluid can flow between the pipe components.

FIG. 1 also shows a pipe connector for clamping together the pipe flanges 1, 1′. The pipe connector has an axisymnetric shape for encircling the flanges 1, 1′, which are similarly configured. The axial direction A and radial directions R are indicated. In the following description the term “outwards” shall be understood as in the direction R, while the term “inwards” shall be understood as facing in the opposite direction to R. Correspondingly, the term “outside” shall be understood as the direction facing away from axis A of the pipe connector and the pipe flanges, that is in the direction R, while the term “inside” shall be understood as facing in the opposite direction to R.

For illustrative purposes the upper part of FIG. 1 shows the pipe connector in its closed position, where the pipe flanges 1, 1′ are clamped against each other, while the lower part of FIG. 1 shows the pipe connector in its open position, where the pipe flanges can be drawn apart from each other. The pipe connector includes a number of fingers, 3, that extend parallel with the axial direction of the pipe connector, A, and are arranged around the circumference of the pipe flanges 1, 1′. The fingers 3 are movable but held in place by the surrounding components. In addition, guides (not shown), for example axial grooves or pins, are used to prevent the fingers 3 being rotated about radial axes R or axes parallel to the longitudinal axis A.

The fingers have inner profiles featuring recesses with bottom surfaces 5 and sloping side surfaces 4, 4′. The pipe flanges 1, 1′ also have sloping surfaces 6, 6′ and the sloped surfaces 4, 4′ of the fingers are shaped so that they fit together with the sloping surfaces 6, 6′ of the pipe flanges when the pipe flanges are facing each other as shown on FIG. 1.

The outer profile of each finger is shaped to provide an actuation surface 10, a clearance point 11 and a ridge 12. The ridge provides an axial stop for a runner ring 15 which is axially slidable along the outer profile. The fingers 3 also have outwardly facing reaction surfaces 13 adjacent to the ridge 12. The pipe connector also includes a stationary retainer ring 14 whose inner surface is engaged by the finger reaction surfaces 13. Cap screws 32 which pass through suitable clearance holes in an axially extending collar 37 of the retainer ring 14 prevent it from moving in the axial direction A. The retainer ring collar is received as a clearance fit in a groove 36 in the pipe component 2′. The cap screws 32 span the groove 36 in the radial direction so as to be rigidly supported in the pipe component 2′. The retainer ring is thus allowed to deform elastically in the radial direction R. The retainer ring 14 and its fastening will be further described later. An adjustment ring 22 is located on the inside of the retainer ring 14.

A runner ring 15 is located outside the fingers 3. The runner ring 15 is retained by followers 18, and is allowed to deform elastically in the radial direction R. The runner ring 15 and its fastening point will be further described later. The followers 18 are fastened to actuator rods 17 that are moved parallel with the axial direction A by hydraulic actuators 16. Operating the actuators therefore results in the movement of the runner ring 15 along the outer profile of the fingers 3. End stops (not shown) for the actuators 16 ensure that the runner ring 15 is restrained to move only between the clearance points 11 and the actuation surfaces 10 of the fingers. The actuators 16 may be included in the connector as shown or alternatively the actuator may be located on an external tool, for example a remotely operated underwater vehicle (ROV).

The pipe connector also includes a reaction ring 26 that is attached to pipe component 2′ by screws 31, creating a reaction point for the hydraulic actuators 16. In addition the pipe connector also includes supply lines (not shown) for hydraulic fluid to the hydraulic actuators 16 and may also include a number of other components, for example hydraulic pistons for moving the two pipe components 2, 2′ away from each other when opening the pipe connector, limit switches to detect the position of the runner ring 15, and hydraulic pipes and/or electrical cables for these components.

When the retainer ring 15 is adjacent the clearance point 11, the fingers 3 are limitedly movable in the radial direction R and limitedly rotatable around imaginary tangential axes centered in the area T, as shown in the lower part of FIG. 1. The fingers 3 are now loose, but retained by the runner ring 15 that abuts the clearance surfaces 11 and ridges 12; the right pipe flange side surface 6′ that abuts the right side surfaces 4′ of the recesses; the retainer ring 14 that abuts the ridges 12 and reaction surfaces 13; as well as grooves 21 in the right pipe component 2′ that abut inner surfaces 34 at the right hand ends of the fingers 3. Because of the mobility of the fingers 3 the left pipe flange 1 can be moved towards or away from the right pipe flange 1′. The pipe connector is now open.

When connecting the two pipe components 2, 2′ together, the pipe flanges are first moved towards each other. The left hand ends of the fingers 3 have sloping end surfaces 33 which together form a guide funnel. This allows the left hand pipe flange 1 to enter the center of the fingers and spread them sufficiently to pass the inner ends of the side surfaces 6. Pins 41 located in the right hand pipe flange 1′ are directed against holes 43 in the left pipe flange 1, so that the pipe flanges 1, 1′ are guided into the correct relative position and a rotational alignment between the two pipe components is achieved. If rotational alignment is not necessary, the pins 41 and holes 43 can be omitted. Alternatively, concentric inter-engageable tongue and groove features on the respective flanges 1, 1′ can be used.

Then the runner ring 15 is moved towards the end of the fingers using the actuators 16 so that the clearance between the runner ring 15 and the fingers 3 disappears and the left hand ends of the fingers are forced inwards. When the runner ring 15 is level with the actuation surfaces 10, the finger sloping surfaces 4 are forced against the side surface 6 of the left hand pipe flange 1. The finger sloping surfaces 4′ are similarly forced against the side surface 6′ of the right hand pipe flange. The finger thereby pivots about the sloping surfaces 6, 6′ forcing the reaction surfaces 13 outwardly, into contact with the adjustment ring 22 which is fastened to the inside of the retainer ring 14. The role of the adjustment ring is to adjust the distance between the retainer ring 14 and the reaction surfaces 13. If desired the adjustment ring 22 can be dispensed with allowing the reaction surfaces 13 to come into direct contact with the retainer ring 14.

It will be seen that the two pipe flanges 1, 1′ are identical. Further, with the actuators 16 fully extended, the axial distance from the side surface 6 of the left pipe flange to the initial contact points between the actuation surfaces 10 and the runner ring 15 is approximately the same as the axial distance from the side surface 6′ of the right pipe flange to the initial contact points between the adjustment ring 22 and the reaction surfaces 13. Assuming low friction between surfaces 4 and 6, and between surfaces 4′ and 6′, then the design is such that the force between the runner ring 15 and each of the fingers 3 is substantially identical to the force between the adjustment ring 22 and each reaction surface 13.

The pressure of the fingers against the retainer ring 14 and the runner ring 15 results in the radial stretching of these components. However, the retainer ring 14 and the runner ring 15 are elastic and will try to return to their unstressed form. This leads to inwardly directed radial forces from the retainer ring 14, onto the adjustment ring 22 and through this onto the fingers 3. Similar inwardly directed radial forces from the runner ring 15 also act on the fingers. These forces press the fingers 3 inward, the recesses of the fingers pressing against the pipe flanges 1, 1′. The sloping side surfaces 4, 4′ press against the sloping surfaces 6, 6′ of pipe flanges and clamp the pipe flanges 1, 1′ together. The pipe connector is now closed.

Manufacturing tolerances of critical components of the connector and pipe flanges may be in the range of +/−0.1 mm. If the sum of the oversizing of the fingers 3, the retainer ring 14, the runner ring 15 and the pipe flanges 1, 1′ is larger than intended, the retainer ring 14 and the runner ring 15 will stretch more in the radial direction than desired. The retainer ring 14 and the runner ring 15 will be elongated more than desired in their circumferential directions and the tension forces in the retainer ring 14 and the runner ring 15 in the circumferential direction, which is dependent upon the circumferential elongation, will be larger than desired. This will lead to the contact forces of the fingers 3 on the retainer ring 14 and the runner ring 15 being larger than desired, and thus the clamping force of the fingers 3 against the pipe flanges 1, 1′ being greater than desired.

However, by forming them from suitable (e.g. superelastic) materials, the retainer ring 14 and the runner ring 15 can have an elasticity that is so large that the variances in their elongation in the radial direction and the consequent circumferential elongation only have a small influence upon the circumferential tensile forces in the retainer ring 14 and the runner ring 15. This will in turn result in an increase in the radial forces of the retainer ring 14 and the runner ring 15 against the fingers 3 and thus an increase in clamping forces of the fingers against the pipe flanges 1, 1′ that is within an acceptable range. Other suitable materials for the retainer ring 14 and runner ring 15 are titanium or carbon fiber and other composites.

Correspondingly, if the sum of the undersizing of the fingers 3, the retainer ring 14, the runner ring 15 and the pipe flanges 1, 1′ is too great, i.e., these components together use a smaller space than intended, the retainer ring 14 and the runner ring 15 will stretch less in the radial direction than desired or intended when the runner ring 15 is moved towards the actuation surfaces 10. Consequently, the radial forces of the fingers 3 against the retainer ring 14 and the runner ring 15 will be less than desired. Again, however, if the retainer ring 14 and runner ring 15 are sufficiently elastic, the reduction in clamping forces will still be within acceptable limits, even with highly undersized critical components.

The retainer ring 14 and the runner ring 15 can absorb these dimensional variances of the components of the pipe connector. The result is a pipe connector where the clamping forces on the pipe flanges are not so dependent on dimensional variances of the pipe connector's components.

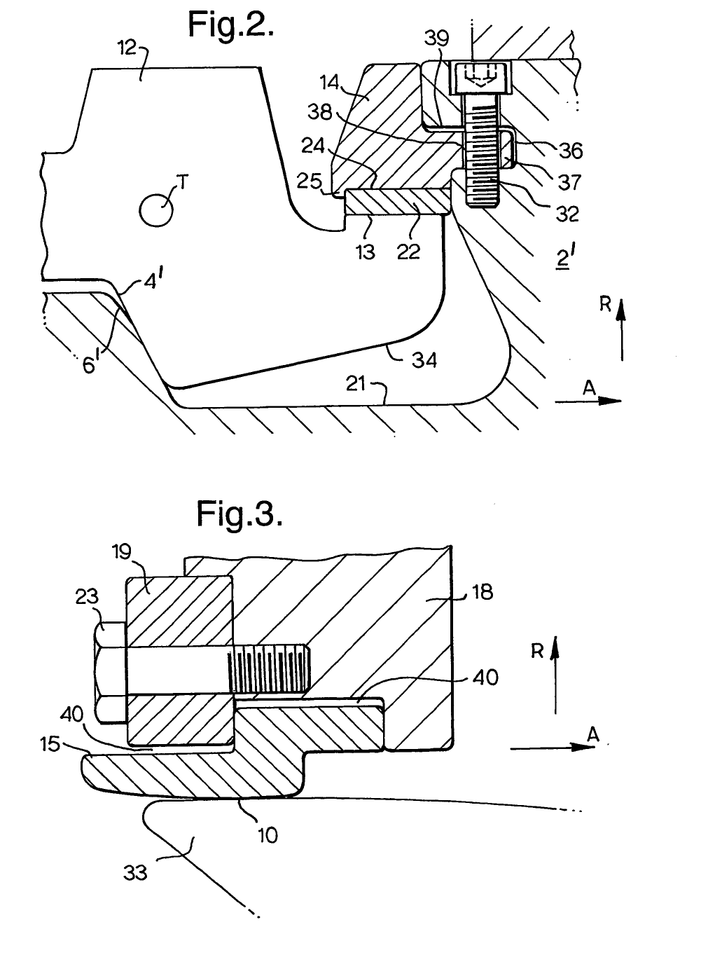

FIG. 2 shows the retainer ring 14 with its components in more detail. The retainer ring has a collar 37 with radial holes 38. The collar 37 is located in a groove 36 in the right hand pipe component 2′. Radial screws 32 attached to the right hand pipe component 2′ are located through groove 36 and pass through holes 38 in collar 37. The holes 38 are slightly larger than the screws 32 allowing retainer ring 14 to stretch radially, within an area delimited by radial clearance 39 between collar 37 and the outer wall of the groove 36. Retainer ring 14 is prevented from rotating or moving in the axial direction A. The adjustment ring 22 bears against the retainer ring 14 with a light interference fit in a recess 24 and is held by a nose 25.

FIG. 3 shows runner ring 15 with its components in more detail. The runner ring 15 is located in notches formed between the followers 18, which hold it in the axial direction, and a support ring 19 that is fixed the followers 18 with screws 23. As previously described with reference to FIG. 1, the followers are moved in the axial direction A by the hydraulic actuators 16. Radial clearances 40 between the runner ring 15 and on the one hand the followers 18 and on the other hand the support ring 19, allow for the radial stretching of runner ring 15. The radial clearances 39, 40 for the retainer ring 14 and the runner ring 15 should be chosen to be of a size such that the retainer ring 14 and runner ring 15 are allowed free radial expansion within the range that will exist with the actual dimensional variances for the components of the pipe connector.

Ideally the elasticity of the retainer ring 14 and runner ring 15 should be the same where the retainer ring 14 and the runner ring 15 exert identical forces against the fingers 3. In order to achieve this, retainer ring 14 and the runner ring 15 should have the same cross sectional area and preferably the same diameter. This is the case with the pipe connector shown on FIG. 1. It is also an advantage if the retainer ring 14 and the runner ring 15 are made of a material of similar elasticity. The adjustment ring can be designed to have no influence on the retainer ring stiffness, e.g. by being circumferentially discontinuous.

The elasticity required for the retainer ring 14 and the runner ring 15 will depend on the actual pipe connector. The elasticity must be such as to enable the dimensional variances of the components of the pipe connector not to cause the stresses in the rings to fall outside the elastic range of the material.

Mathematically this an be expressed as:
σ=ΔD×(E/D)
where σ is the tensile stress of the ring in the circumferential direction in N/mm², D is the rings diameter in mm, ΔD is the expansion of the diameter of the ring in mm, and E is the elastic modulus for the material in the ring in N/mm².

The majority of components in the load path of the pipe connector (preferably all except the retainer ring 1A and load ring 15) are made of steel, with an elastic modulus of around 206 000 MPa. The maximum permissible tensile stress σₘₐₓ for steel is typically 400 N/mm².

By careful design of the pipe connector components one can achieve a clamping force between the flanges 1, 1′ in the axial direction A of 12 000 kN for a connector for pipes of 17″ (432 mm). The sum of the dimensional tolerances for the fingers 3, the retainer ring 14, the runner ring 15 and the pipe flanges 1, 1′ will be 0.1 to 0.2 mm, and it is essential that the pipe connector is designed such that these dimensional variances do not cause the clamping force between flanges 1, 1′ to become too large nor tensile stress in the rings to exceed σₘₐₓ.

Pipe flanges with similar outer profiles may be dimensioned for different pressure ratings. A pipe flange designed for high pressure ratings will require a greater thickness, while a flange dimensioned for lower pressure will be smaller. This difference in material thickness will manifest itself in a difference in the bore diameter D of the flow conduits 35, 35′. Flanges for high pressure demand a large clamping force because of this increased thickness while flanges for lower pressure ratings demand smaller clamping forces so as not to overload the flanges.

When the runner ring 15 during closing of the pipe connector is moved towards the actuation surfaces 10, the fingers 3 will pivot about flanges 1, 1′ and the ends of the fingers with the reaction surfaces 13 will move towards the adjustment ring 22. When using a thin adjustment ring 22, that is an adjustment ring of small radial thickness, before contacting the adjustment ring 22 the reaction surfaces 13 will move to a position closer to the retainer ring 14 than when using a thick adjustment ring 22. A thin adjustment ring 22 will therefore result in the runner ring 15 pushing the fingers further inwards before forces arise between side surfaces 4, 4′ of the fingers and the side surfaces 6, 6′ of the flanges. A pipe connector with a thin adjustment ring will therefore in its closed position exert smaller clamping force than a pipe connector with a thick adjustment ring. By appropriate choice of radial thickness of the adjustment ring 22, the clamping forces of the fingers against the pipe flanges 1, 1′ can be predetermined so that the clamping forces can be adapted to the flanges concerned. The adjustment ring 22 is preferably exchangeable to enable changing of the clamping forces of the fingers 3 against the flanges 1, 1′, thus making it possible to use the connector for a range of flanges demanding different clamping forces.

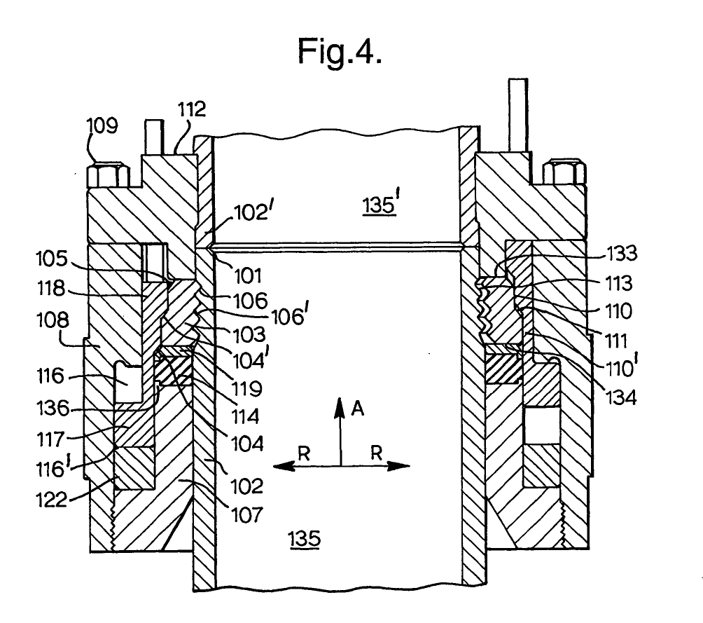

FIG. 4 shows two tubular components 102, 102′ each with a flow passage 135, 135′. The components are parts of completion equipment located vertically on the sea floor. In this example the lower component 102 is a wellhead while the upper component 102′ can be a BOP, a Christmas tree or a riser. For simplicity, this component 102′ is referred to below as a BOP. The wellhead 102 has a plurality of circumferential grooves 113 formed on its exterior to provide a locking profile. A connector upper body 112 is shown locked to the BOP 102′. By sliding the connector over the tubular component 102 a connection between the flow passages 135, 135′ is established so that fluid can flow between the tubular components.

FIG. 4 also shows further components of the connector for clamping together the wellhead and BOP. The connector has a housing generally designated 107 with a mainly axisymmetric shape for encircling the wellhead, which is also axisymmetric. Reference A indicates an axial direction and reference R radial directions. In the following description the term “outwards” shall be understood as the direction away from the axis A of the wellhead connector and completion components, that is in the direction R, while the term “inwards” shall be understood as facing in the opposite direction. Correspondingly, the term “outside” shall be understood as the direction facing away from the axis A, that is in the direction R, while the term “inside” shall be understood as facing in the opposite direction.

For illustrative purposes only, the left hand side of FIG. 4 shows the connector in its locked position, where the BOP 102′ is clamped against wellhead 102, whereas the right hand side shows the connector in its unlocked or free position. The wellhead connector includes a number of dogs 103 that are arranged around the circumference of the wellhead upper end 101. The dogs 103 are free bodies held in the position shown by surrounding components. In addition, guides (not shown), for example radial windows in which the dogs are housed, may be used to prevent the dogs 103 moving out of proper position. Instead of dogs, a locking ring, segmented or with a single radial split, can be used. The dogs have complementary grooved inside surfaces opposed to the grooves 113 in the wellhead end 101, so that when the connector is closed, the inside surfaces of the dogs fit into the grooves 113.

The dogs 103 furthermore have outside surfaces facing away from the wellhead end 101 and having an upper, inner, gently upwardly and inwardly tapered cam surface 110 and a lower, outer gently upwardly and inwardly tapered cam surface 110′. Between these cam surfaces, the outer surfaces of the dogs slope more steeply upwards and inwards, creating a frustoconical middle surface portion 111.

A follower 118 is rigidly fastened to or formed integrally with an actuator piston 117 and can be moved parallel with the axial direction A by supplying hydraulic fluid to cylinders 116, 116′. Actuating the piston therefore results in movement of the follower 118 along the dog 103 outside surfaces. With the piston 117 and follower 118 in their uppermost position (FIG. 4, right-hand side), the dogs 103 are fully retracted. Here the middle surface portion 111 lies against a correspondingly relatively steeply sloping surface 104 on the follower 118. A further steeply sloping surface 104′ on the follower 118 lies against an upper cam surface 105 on the dog outer surface. As the piston moves downwardly, the dogs are moved radially inwardly by the follower, at first relatively rapidly by co-operation between the surfaces 104, 111 and 104′ 105. Then the dogs are moved inward more slowly but with greater mechanical advantage and hence greater clamping force, by co-operation between the gently tapered cam surfaces 110, 110′ on the dogs and correspondingly tapered surfaces on the follower, as shown in FIG. 4, left-hand side. An adjustment ring 122 is located in cylinder 116′, limiting the travel of the piston in the cylinder. By appropriate choice of thickness in the adjustment ring 122 in the axial direction, the clamping force of the dogs against the wellhead end grooves 113 can be limited so that the clamping force can be adapted to different wellhead types. The adjustment ring 122 is preferably exchangeable, thus making it possible to use the connector on wellheads demanding different clamping forces.

A relatively highly elastic ring 114 is sandwiched axially between housing 107 and a support ring 119. The elastic ring 114 is allowed to be axially compressed, at the same time being maintained against rotation. Elastic ring 114 may be wholly made of the highly elastic material (e.g. superelastic metal such as shape memory alloy, or other materials having a lower elastic modulus than steel, e.g. titanium or carbon) or it may be made up of one or more layers of rings of low modulus interspaced with rings made of other materials.

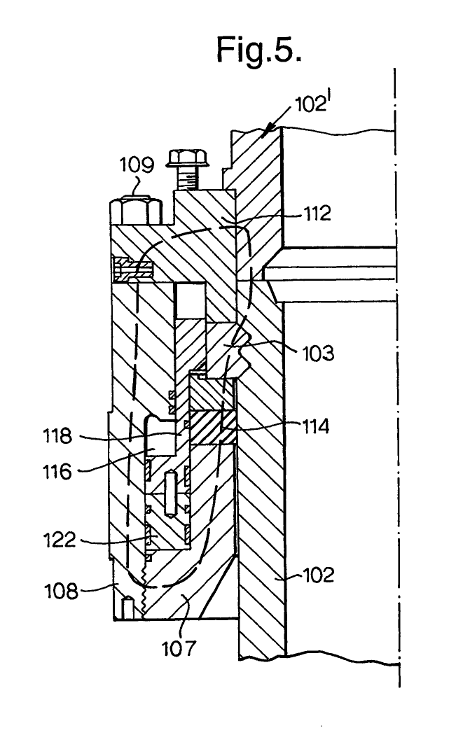

In operation, the wellhead connector will be lowered over the wellhead end 101 until it reaches the position shown in FIG. 4. Initially, the dogs 103 will be in the retracted position. The piston 117 will be in the upper position. Then hydraulic fluid is supplied to the cylinder 106 to move piston 117 downward and this will bring along with it the follower 118 and cause the dogs 103 to move inward to the locked position. The axial thickness or height of the elastic ring 114 and/or the support ring 119 is chosen so that the dogs 103 engage the upper (downwardly facing) flanks of the grooves 113 before the dogs 103 are fully extended. Further extension of the dogs 103 applies compressive preloading across the mating faces of the wellhead 102 and BOP 102′. This preload is reacted through the groove 113 upper flanks, the dog 103 lower faces 134, the support ring 119, the elastic ring 114, the connector housing 107, a connector lower body 108, then via bolts 109 to the connector upper body 112 and hence to the BOP. This loadpath is shown schematically by the heavy broken line in FIG. 5. The thickness of the rings 114, 119 can be selected to provide the appropriate size of preload between the BOP and wellhead mating faces, by adjusting the point during their inward movement at which the dogs 103 first encounter the groove 113 upper flanks. The elastic ring 114 accommodates relatively large dimensional tolerance stackups along the loadpath, whilst ensuring that the preload stays within acceptable bounds.

As can be seen from FIG. 5, the forces caused by bending will also travel through the connector as shown by the dashed line. The retainer ring 114 is located such that it is placed in the load path.

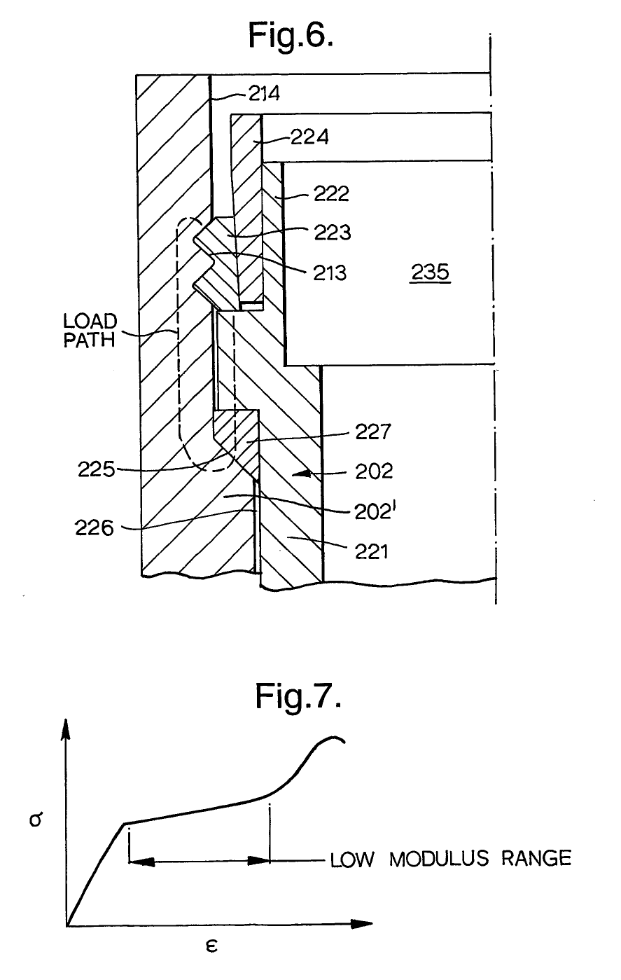

FIG. 6 shows another embodiment of the invention with two tubular components 202, 202′ in coaxial relationship with a common flow passage 235. The left component 202′ is a wellhead housing, tubing spool or christmas tree (hereafter christmas tree, for brevity), while the right component 202 is a tubing hanger. Christmas tree 202′ has an upper inner wall 214 and a lower inner wall 226, the lower inner wall being of a smaller diameter than the upper wall. Between these walls is defined an inwardly facing load shoulder 225. A plurality of circumferential grooves 213 are formed in the upper wall 214 of the christmas tree to provide a locking profile.

The tubing hanger 202 includes a lower body 221 and an upper body 222. The lower body has an outer diameter ensuring a sliding fit within the lower inner wall 216 of the christmas tree while the upper body 221 has a part that likewise is a sliding fit within the upper inner wall 214 of the christmas tree. A lockdown ring 223 is carried by the upper tubing hanger body 222 and actuated between a retracted position and a locked position by a segment 224. Between the upper and lower tubing hanger parts is defined a downward facing shoulder 227 intended for mating with the load shoulder 225, thereby supporting the tubing in the well.

According to this embodiment of the invention a ring with high elasticity, i.e. low modulus value, is exchanged for the commonly used tubing hanger load shoulder insert, to form the downwardly facing shoulder 227. The insert can be a separate ring connected to the tubing hanger body, or formed as an integral part of the tubing hanger body (as shown).

The low modulus insert solves the same problem for the lockdown of the tubing hanger body as for preloading the connectors described above. A stackup of machined tolerances affects preload within the lockdown mechanism. An acceptable preload is conventionally achieved by tightly controlled and therefore expensive machining tolerances. Use of the elastic insert accommodates larger dimensional tolerance stackups whilst maintaining an acceptable preload, making the Christmas tree and tubing hanger easier and cheaper to manufacture.

The desired insert 223 or ring 114, 14, 15 properties can be obtained by using a material that is in a superelastic phase. The material must be designed such that operating loads would be in the low elastic region, as shown in FIG. 7.

1. A mechanical connector for an oil and gas well apparatus which applies a predetermined preload across a connection, the preload being adapted to accommodate relatively large dimensional tolerances in the load path of the connector preload by placing within that load path a component with a low modulus of elasticity in comparison to the remainder of the load path.

2. A connector as defined in claim 1 which comprises:
a plurality of fingers which are located circumferentially around a pair of pipe flanges and which each include a finger reaction surface;
a stationary retainer ring against which each finger reaction surface is pressed; and
a runner ring which is located radially outside the fingers and is movable lengthwise along the fingers by an actuator;
wherein the retainer ring and the runner ring have an elasticity that is so large that deviations in their elongation only have a small influence on the radial pressure of the retainer ring and the runner ring against the fingers and the clamping forces of the fingers against the flanges.

3. A pipe connector as defined in claim 2, wherein the retainer ring and the runner ring are freely radially stretchable.

4. A connector as defined in claim 2, wherein the retainer ring and the runner ring have substantially the same cross sectional area.

5. A connector as defined in claim 2, wherein the retainer ring and the runner ring are made of a material of substantially the same elasticity.

6. A connector as defined in claim 2, wherein the retainer ring and the runner ring have substantially the same diameter.

7. A connector as defined in claim 2, further comprising an adjustment ring which is located radially inside of the retainer ring, and which comprises a radial thickness that is selected to provide desired clamping forces for the fingers against the pipe flanges.

8. A connector as defined in claim 7, wherein the adjustment ring is interchangeable for changing the clamping forces of the fingers against the pipe flanges.

9. A connector as defined in claim 1, further comprising:
a plurality of dogs which are located circumferentially around a first tubular joint component; and
a follower which is located radially outside the dogs and is movable axially of the dogs;
wherein the low elastic modulus component comprises a ring which is located in the loadpath adjacent the dogs.

10. A connector as defined in claim 9, wherein the first tubular joint component comprises a wellhead which is connected by the connector to a second tubular component which comprises one of a riser, a Christmas tree or a BOP.

11. A connector as defined in claim 1, further comprising:
a lockdown mechanism which is operatively engaged between a pair of nested components;
wherein the low elastic modulus component comprises an insert comprising which includes a load shoulder that transfers loads between the nested components.

12. A connector as defined in claim 12, wherein the nested components comprise a tubing hanger and one of a wellhead, a tubing spool or a Christmas tree.

13. A connector for releasably securing a first component to a second component, the connector comprising:
at least one locking member which is movably supported on the first component;
means for moving the locking member into engagement with at least the second component to thereby secure the first component to the second component; and
a first reaction member through which the locking member reacts as the locking member is moved into engagement with the second component;
wherein the first reaction member is made of a material which has a lower modulus of elasticity than that of both the locking member and the first and second components.

14. The connector of claim 13, wherein the first reaction member is made of a superelastic material.

15. The connector of claim 13, wherein each of the first and second components comprises a respective first and second flange and the connector comprises:
a plurality of fingers which are located circumferentially around the first and second flanges and which each comprise a reaction surface and an actuation surface;
a retainer ring which is connected to the first component generally opposite the reaction surfaces;
a runner ring which is movably supported on the first component; and
means for moving the runner ring into engagement with the actuation surfaces;
wherein when the runner ring is moved into engagement with the actuation surfaces, the fingers will move into engagement with the flanges to thereby secure the first and second components together; and
wherein the at least one locking member comprises the plurality of fingers, the first reaction member comprises the retainer ring, and the means for moving the locking member comprises the runner ring and the means for moving the runner ring.

16. The connector of claim 15, wherein the runner ring is comprised of a material which has a lower modulus of elasticity than that of both the locking member and the first and second components.

17. The connector of claim 15, wherein the retainer ring and the runner ring are each made of a superelastic material.

18. The connector of claim 15, wherein the retainer ring and the runner ring have substantially the same cross sectional area.

19. The connector of claim 15, further comprising an adjustment ring which is attached to the retainer ring opposite the reaction surfaces and which comprises a radial thickness that is selected to provide a desired clamping force for the fingers against the first and second flanges.

20. The connector of claim 19, wherein the adjustment ring is removably attached to the retainer ring.

21. The connector of claim 13, wherein each of the first and second components comprises a respective first and second tubular member and the connector comprises:
a plurality of locking dogs which are movably supported on the first tubular member generally opposite a locking profile which is formed on the second tubular member;
a follower which is movably supported on the first tubular member;
means for moving the follower into engagement with the locking dogs; and
a reaction ring which is fixed relative to the first tubular member adjacent the locking dogs;
wherein when the follower is moved into engagement with the locking dogs, the locking dogs will move into engagement with the locking profile to thereby secure the first and second tubular members together; and
wherein the at least one locking member comprises the plurality of locking dogs, the first reaction member comprises the reaction ring, and the means for moving the locking member comprises the follower and the means for moving the follower.

22. The connector of claim 21, further comprising:
an upper body which is connected to the first tubular member;
a lower body which is connected to the upper body; and
a connector housing which is connected to the lower body and which is positioned coaxially around the second tubular member;
wherein the locking dogs are supported on the connector housing and the reaction ring is disposed between the connector housing and the locking dogs; and
wherein the reaction ring is made of a material which has a lower modulus of elasticity than that of the upper body, the lower body and the connector housing.

23. The connector of claim 22, further comprising a support ring which is positioned between the reaction ring and the locking dogs and which comprises a thickness that is selected to provide a desired clamping force for the locking dogs against the second tubular member.

24. The connector of claim 13, wherein the first component comprises a tubular hanger, the second component comprises a tubular housing in which the hanger is supported, and the connector comprises:
a lockdown ring which is movably supported on the hanger generally opposite a locking profile which is formed on the housing;
a locking mandrel which is movably supported on the hanger;
means for moving the locking mandrel into engagement with the lockdown ring; and
an insert ring which is positioned between the hanger and the housing;
wherein when the locking mandrel is moved into engagement with the lockdown ring, the lockdown ring will move into engagement with the locking profile to thereby secure the hanger to the housing; and
wherein the at least one locking member comprises the lockdown ring, the first reaction member comprises the insert ring, and the means for moving the locking member comprises the locking mandrel ad the means for moving the locking mandrel.
